(19) United States
(12) Patent Application Publication
(10) Pub. No.: US 2010/0320214 A1
(43) Pub. Date: Dec. 23, 2010

(54) CONTAINER AND CHIME AND METHOD OF MANUFACTURING SAID CONTAINER

(76) Inventors: Albert Wauters, Destelbergen (BE); Iain McDerment, Hertfordshire (GB)

Correspondence Address: Levy & Grandinetti, P.O. Box 18385, Washington, DC, 20036, US

(21) Appl. No.: 12/449,488

(22) PCT Filed: Feb. 12, 2008
(86) PCT No.: PCT/EP2008/051685

§ 371 Date: Aug. 20, 2010

(30) Foreign Application Priority Data
Feb. 12, 2007 (GB) 0702672.7
Dec. 14, 2007 (GB) 0724455.1

(51) Int. Cl. B65D 6/28; B23P 17/00

(52) U.S. Cl. 220/623; 29/527.1

(57) ABSTRACT

Container assembly comprising a container and a chime fixed to each other, the container having an end part and a peripheral side wall, characterized in that the fixation between the chime and the container is situated at the end part of the container and at a distance from said peripheral side wall.

The Applicants claim priority to International Application No. PCT/EP2008/051685, filed on Feb. 12, 2008, Great Britain Application No. 0724455.1, filed on Dec. 14, 2007, and Great Britain Application No. 0702672.7, filed on Feb. 12, 2007.

### FIELD OF THE INVENTION

The present invention relates to containers, particularly kegs and to chimes provided at the bottom part of said containers, as well as to a method for manufacturing such containers.

### BACKGROUND OF THE INVENTION

It is general practice to provide a container or keg with bottom and top chimes. These chimes usually perform several functions. A first is function is purely protection of the base and top part of the kegs such that they are not damaged during handling. The base chime also provides a flat base for the keg, such that this can easily be placed in an upright position. In most cases, the top and bottom chime are designed to make kegs stackable and as such simplify transport and storage of the kegs. A further important function of chimes is to facilitate handling of the kegs. Indeed, most chimes are provided with a skirt that in a mounted position is situated at the periphery of the keg and that forms a rolling ring, such that when kegs are provided with bottom and top chimes, the kegs can be rolled easily when placed on their side, without the kegs sidewall touching ground.

In order to fix the chimes on a keg, several options are known. In most cases however the chimes are welded to the sidewall of the keg, which has the drawback that once applied, the chimes can not be released or replaced.

This drawback has been overcome by DE3336681, wherein a chime is described that is snap-fitted behind protrusions provided at the periphery of a corresponding keg. In this case the chimes can be readily removed and replaced from the keg which simplifies both repair and recycling of both chimes and kegs.

With the growing demand for plastic kegs and the growing need for recycling and cost reducing processing, the application of the chimes on the kegs and the removal of said chimes off the kegs needs to be further simplified.

### SUMMARY OF THE INVENTION

The present invention nuts the above objectives by providing a container assembly comprising a container and a chime fixed to each other, the container having an end part and a peripheral side wall, characterized in that the fixation between the chime and the container is situated at the end part of the container and at a distance from said peripheral side wall.

The end part preferably is the base of the container, the chime, a bottom chime.

By redesigning the fixation of the chimes to the container, the applicant moved the attachment means to a central part of the base of the container. By doing so, the fixation of the chimes is no longer dependent on the peripheral circumference of the container. This offers the advantage that the fixation of the chime to the container can be made equal for containers of different dimensions, which clearly simplifies automation and processability, especially with regard to recycling.

Further advantages associated with various embodiments of the present invention include the snap on assembly of the chime, as it engages the keg bottom finish, (which of course, lends itself to automated production). Moreover, in cases where no other means of fixation is employed, the bottom chime can be readily removed and recycled separately from the keg, and if appropriate easily replaced by another replacement chime so that the keg can be returned to production. In addition, the bottom chime provides for ease of handling, and its resilient flexibility provides for drop resistance benefits.

Preferably, the fixation between chime and container is releasable, such that the chimes can easily be replaced when damaged. In the most preferred embodiment, the fixation is achieved by a snap fit between the chime and the container.

The present invention also relates to the container itself, as in order to enable the above fixation, the container according to the invention has a base that is provided with attachment means situated at a distance from the containers peripheral sidewall.

A chime according to the invention comprises at least a inner hub provided with fixation means and an outer skirt that is designed to engage part of the peripheral sidewall of a container.

Finally, the present invention also relates to a method for manufacturing a container according to the present invention, which method comprises providing attachment means at a base of the container and at a distance of the containers peripheral sidewall.

Preferably, the container is manufactured in a thermoplastic material that is molded in a mold, whereby the attachment means are created by using a mold having a cavity defining a sump region in the that part of the mold cavity that corresponds to the base of the container to be formed therein.

Preferably, the method further comprises inserting a rod in the mold cavity during molding, which rod extends until in the sump defining region of the mold cavity.

The use of such rod is particularly advantageous in case of blow-molding the container, as it helps forcing the thermoplastic material in the sump region, thereby forming the attachment means, in particular the snap fit at the base of the container.

### INTRODUCTION TO THE DRAWINGS

FIG. 1 of the drawings appended hereto depicts a top-down elevated perspective view into an embodiment of a plastic bottom chime according to the present invention.

FIG. 2 of the drawings appended hereto illustrates an underside, elevated perspective view of an embodiment of a plastic bottom chime according to the present invention.

FIG. 3 of the drawings is a cross-sectional view taken through the bottom chime according to the present invention, in combination, (i.e. in mounted relation) on a beer keg of the present invention.

FIG. 4 of the drawings is a more detailed view of the cross-section depicted in FIG. 3.

FIG. 5 depicts a schematic cross-sections through a stretch blow mold according to one aspect of the present invention.

FIG. 6 is an elevated cross sectional view of a chime and keg assembly according to the present invention.

FIG. 7 of the drawings appended hereto depicts a top-down elevated perspective view into a alternative embodiment of a plastic bottom chime according to the present invention.

FIG. 8 of the drawings appended hereto illustrates an underside, elevated perspective view of the embodiment of a plastic bottom chime represented in FIG. 7.

### DETAILED DESCRIPTION OF A PREFERRED EMBODIMENT

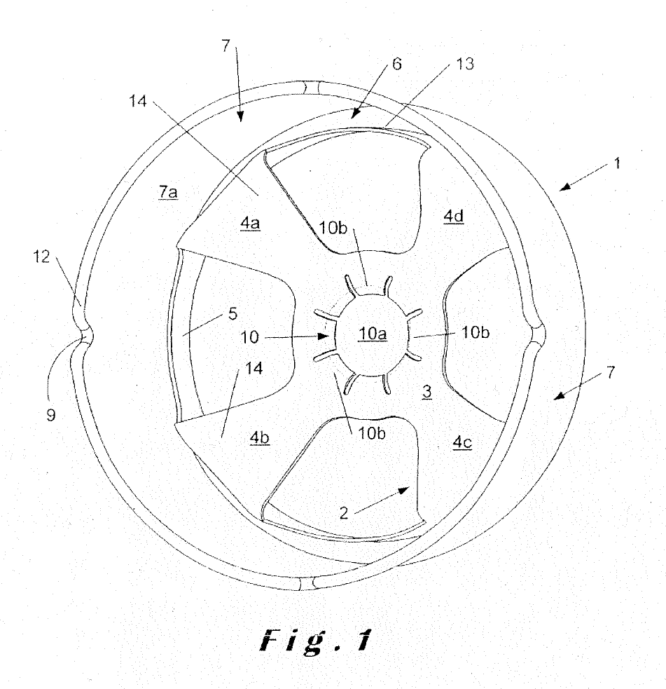

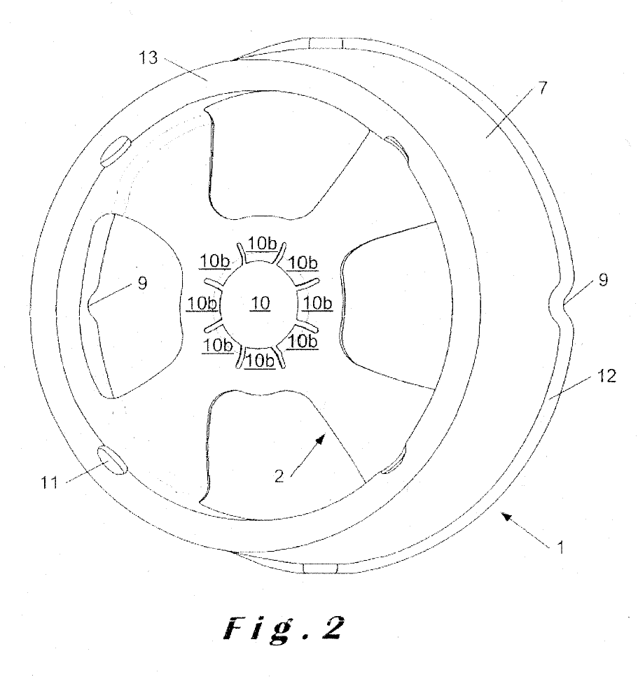

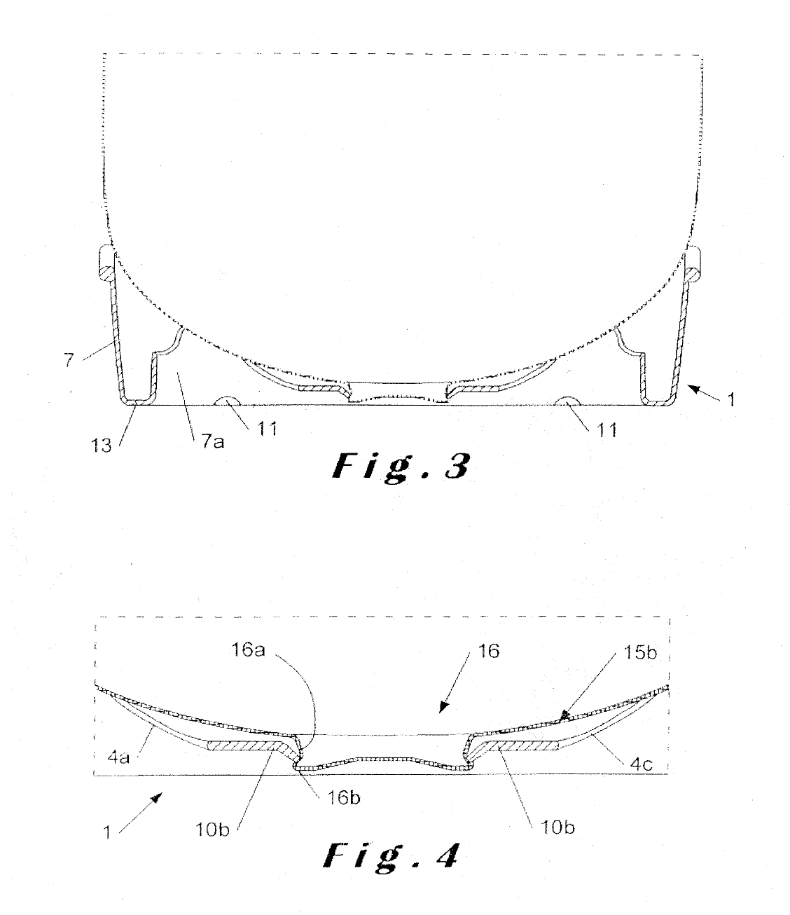

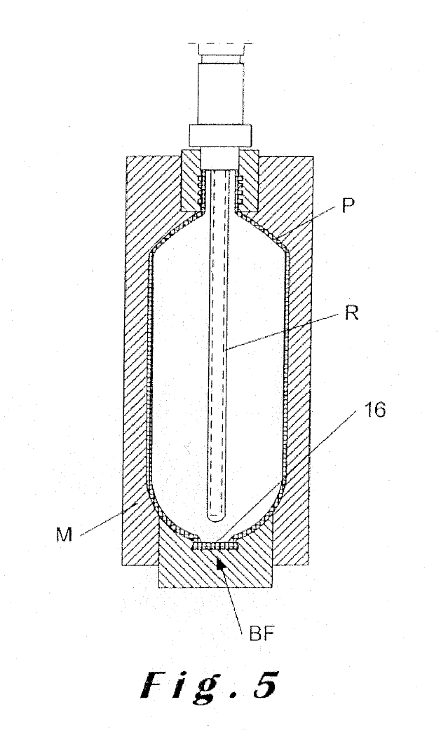

Referring in general to FIGS. 1 and 2 of the appended drawings, there is provided a preferred keg bottom chime 1 according to the present invention. Keg bottom chime 1 comprises a keg bottom finish surround 10. Surround 10 is specifically adapted to engage a cooperating keg bottom finish (not shown in FIGS. 1 and 2, but refer instead to FIGS. 3 and 4). That engagement sustains a mutually inter-fitting secured relation to thereby at least partially secure the chime to the keg.

In this preferred form of the chime 1 according to the present invention, surround 10 comprises an opening 10a, which is circumscribed by respective free ends 10d of a plurality of resilient, flexible tines 10b. Tines 10b extend radially inwardly into opening 10a, from fixed ends of said tines 10b that are rooted on a inner, preferably central hub 3.

Chime 1 includes a “spider” 2 for engaging a bottom portion of a keg body (again, not shown in FIGS. 1 and 2, refer to FIGS. 3 and 4 and the description that follows below), in cradled relation in the chime 1. The spider 2 in turn comprises the central hub 3 with a plurality of radially outwardly extending legs or spokes 4. These spokes terminate at a rim wall 5, with rim wall 5 defining one side of a channel 6 that is further bounded at the bottom thereof by a chime base 13, and surrounded on a spaced apart side by an wall surface 7a of an upstanding chime skirt 7.

Spokes 4a, 4b, 4c and 4d, have contours 14, (e.g. are scallop-shaped) to provide a stiffened girder effect.

The upstanding chime skirt 7 supports a peripheral bead 12 adapted to engage adjacent peripheral sidewall surfaces of a secured keg body.

Skirt 7 also includes keg body drains 9 for draining liquids accumulating between the skirt 7 and an associated keg body peripheral sidewall. When in use, keg assemblies according to the present invention can accumulate water or other liquids that would remain trapped between the chime and the keg when the assembly is oriented in its normal upright position, but which is permitted to drain away through these drains 9.

Similarly, bottom channel bottom 6 includes channel drains 11 for draining liquids accumulating with channel 6. Notably, keg assemblies according to the present invention are often washed and filled in an inverted orientation, during which time water might otherwise accumulate in the channel unless permitted to drain away through these drains. Note that the keg of the present invention and assemblies comprising same are preferably closed-system kegs.

Referring now FIGS. 3 and 4 in particular, there is shown a cut away section of lower portions of keg body 15. Body 15 comprises a peripheral sidewall 17 and a base 15a. The base 15a having a keg body bottom finish 16, which is adapted to engage a complementary keg bottom finish surround 10 of keg bottom chime 1 illustrated in FIGS. 1 and 2.

Bottom finish 16 includes tapered side walls 16a extending proud of the periphery of the keg body 15 and terminating in an overhanging abutment 16b that is particularly suited to engage in inter-fitting secured relation with the complementary features of bottom chime 1 as described elsewhere herein.

It is apparent that the bottom finish 16 forms an attachment means that can cooperate with the fixation means (keg bottom finish surround 10 with tines 10b) of the chime, and that according to the present invention, the fixation of the chime to the keg is situated at a distance of the kegs periphery.

Referring now to FIG. 5 of the drawings, there is shown an example of a blow mold useful in variously forming keg bodies for use in the present invention, from blow molded thermoplastics material. Both of the exemplary molds for producing their respective keg bodies, comprise respective means for forming the keg bottom finishes that are described elsewhere herein.

More particularly FIG. 5 illustrates a stretch blow molding mold and comprises a stretch rod adapted to extend internally of a sump defining region in the base of surround blow mold cavity. The stretch rod and the blow mold cavity co-operate to form a keg having a bottom finish (see finish 16 in FIGS. 3 and 4, for example) which includes tapered side walls (see FIGS. 3 and 4, ref. 16a) extending proud of the periphery of said keg body, and terminating in an overhanging abutment 1 (see FIGS. 3 and 4 and reference numeral 16b, by way of example) that is adapted to engage in said inter-fitting secured relation with bottom chime 1.

Under the preferred practice, the invention relates to the use of blow molding processes. The family of blow molding processes are employed in the production of hollow-bodied thermoplastic articles including, in particular, containers such as bottles. The basic process entails the production of pre-shaping the thermoplastic material into an intermediate for that is referred to as a parison or perform. The heated perform is then further shaped by inflating it under gas pressure, within the constraints of a mold cavity that is designed to provide the final shape of the article.

Blow molding technology in the industrial sense, dates from the late 1930s—but its widespread commercial application was triggered in the 1950's with the introduction of high density polyethylene and the availability of non-proprietary production equipment. Since then, a variety of other thermoplastic materials (in particular with the growth of polyesters as compared with the polyolefin's—which have in some cases been associated with “flavor scalping” and concomitant swelling and increase in oxygen permeability in some beverage packaging applications) have come into use, and while high density polyethylene HDPE continues to account for as much as 55% of all blow-molded thermoplastic material, polyethylene terephthalate (PET) accounts for nearly 88% of the balance. Markets for the more expensive but, in some performance respects, superior polyethylene naphthalate (PEN) are also quickly developing, especially in returnable reusable applications.

The family of blow-mold processes includes “extrusion”, “injection” (and its relative “displacement”) and “stretch”, (a.k.a. “biaxial-orientation”) blow molding, as well as a number of hybrids thereof.

Extrusion blow molding is currently the most widely used of these techniques and it consists of extruding, (either intermittently or continuously), a hollow parison in a downward dropping direction. When the parison has grown sufficiently, a predetermined length thereof is embraced within a mold cavity, (e.g. by closing off two complementary mold halves around the predetermined length of the descending parison). Reciprocating screw and dual screw extrusion machines equipped with a secondary accumulator and ram for intermittent parison extrusion, are employed for small container production. For large containers, up to and including drums, however, an accumulator-head extruder with a plunger feed is employed.

Once the parison P, see FIG. 5, is engaged within the mold M, it is inflated under gas pressure and conforms to the rigid internal surfaces of the enclosing cavity mold, taking on a hollow-bodied shape that will ultimately lead to that of the finished container, which can include the formation of the keg bottom finish 16. Note that while older blow molding machines required an additional reaming action to bring container finishes to final specifications (and presented problems with debris being left behind within the resulting bottle), this problem has been overcome for smaller containers through the cooperative interaction of the glow pin and the mold neck ring while the blown bottle is still resident in the mold. However, wide-mouth blow molded containers still must be finished in a subsequent trim press operation.

Injection blow molding is a multi-stage operation (historically a two step, but now almost universally a three step operation) in which the parison is injection molded into a space defined by a parison mold and a core rod disposed therein, (instead of being extruded), and is then transferred (e.g. on the core rod) into a subsequent blow-molding station. In a “displacement” variant of this type of blow molding, a measured quantity of thermoplastic melt is inserted in a parison mold, and the core rod is then inserted into the mold to forcibly displace the melt into the spaces remaining between the core rod and the molds inner surfaces—thus forming the parison.

Stretch blow molding is particularly suited to applications involving thermoplastics capable of taking up internal linear molecular orientations—such as PET. The parison can be either extrusion molded or injection molded, although the latter is most often used in association with stretch blow molding operations. What specifically characterizes the stretch blow mold process is that the preformed parison is carefully conditioned to just above the thermoplastic's glass transition temperature (i.e. where it is warm enough to permit the parison to be inflated but cool enough to retard post-alignment re-randomization of the molecular structure), and then stretched, oriented, (“partial” and axially or bi-axially) and blown. The strain-induced crystallization in the stretched thermoplastic can, in the case of PET be increased by as much as 20, and even to as high as 28%.

A core rod R is employed as shown in FIG. 5. Note that in a particularly preferred practice of the present invention, and in addition to providing for a component of the axial stretching of parison P during the blowing operation, rod R can also be extended to force plastic material into a portion BF of the mold cavity M, to produce exterior keg bottom finish 16. Portion BF includes means for clamping finish 16 to produce a waist at 16a, which then broadens out at 16b.

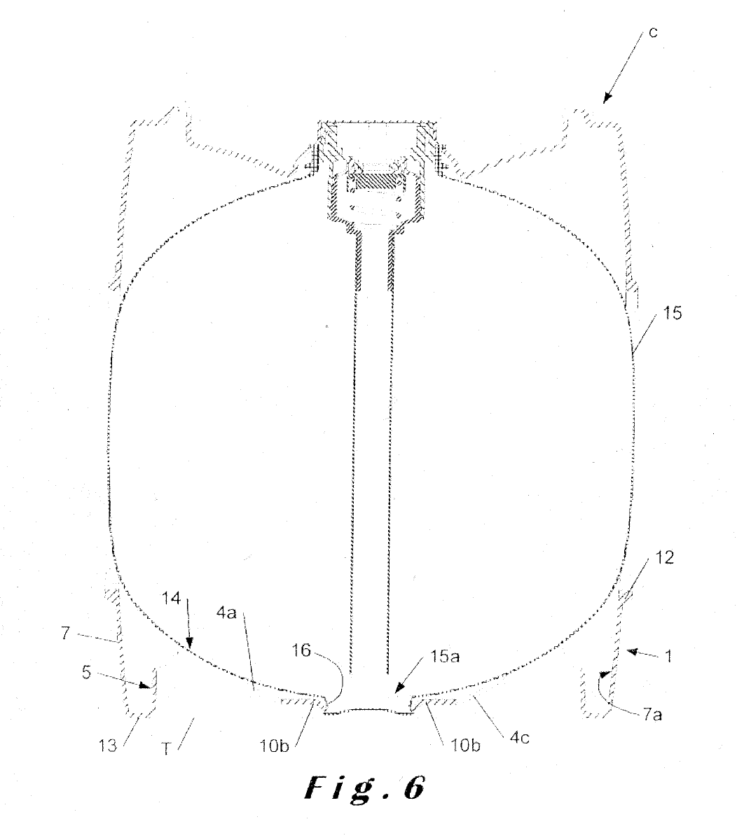

Finally, there is provided a keg and chime assembly as illustrated in FIG. 6. In that connection, reference is made to FIGS. 1 through 4 and 6. The assembly comprises keg body 15 having a base 15a bearing a keg body bottom finish 16. Keg bottom chime 1 comprises a keg bottom finish surround 10. The keg bottom finish surround 10 and the keg bottom finish 16 are mutually adapted to engage a cooperating keg bottom finish in inter-fitting secured relation to thereby at least partially secure said chime and keg in mutually assembled relation. In the variously illustrated embodiments, the inter-fitting secured relation is a resiliently biased mechanically interfering registration between the salient portions of keg 15 and said chime 1. As illustrated in FIG. 6, the bottom chime 1 is depicted at rest, in stacked relation on a cooperative surface T of a supporting keg, not shown, but substantially identical to the top chime C illustrated in surmounted relation on the top of keg 15.

It is clear that in order to fix a chime 1 according to the invention to a keg, it suffices to position the chime 1 with the opening 10a over the keg bottom finish 16 and to press it down such that the flexible tines snap behind the overhanging abutment 16b.

In the case the keg is a plastic keg, it is preferred to provide an internal overpressure in the keg in order to avoid any deformation thereof during fixation of the chime 1.

For removal of the chime 1, one can tear of the chime 1, although the removal can easily be automated by use of a cylindrical drill, breaking the tines 10b, whereby the chime 1 will fall of the keg as are the tines 10b. Such automated and simple removal of the chime obviously simplifies recycling the keg assemblies.

It is noted that when kegs of different dimensions but with standardized bottom finishes, the assembly of the chime 1 and keg can be automated independent of the keg dimensions. Such automation is particularly useful for recycling as no sorting of the kegs is necessary.

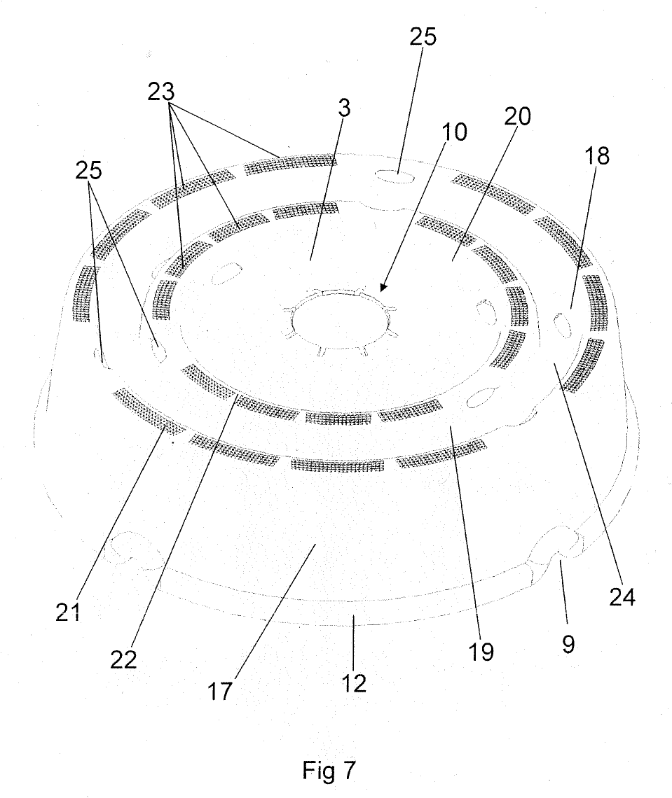

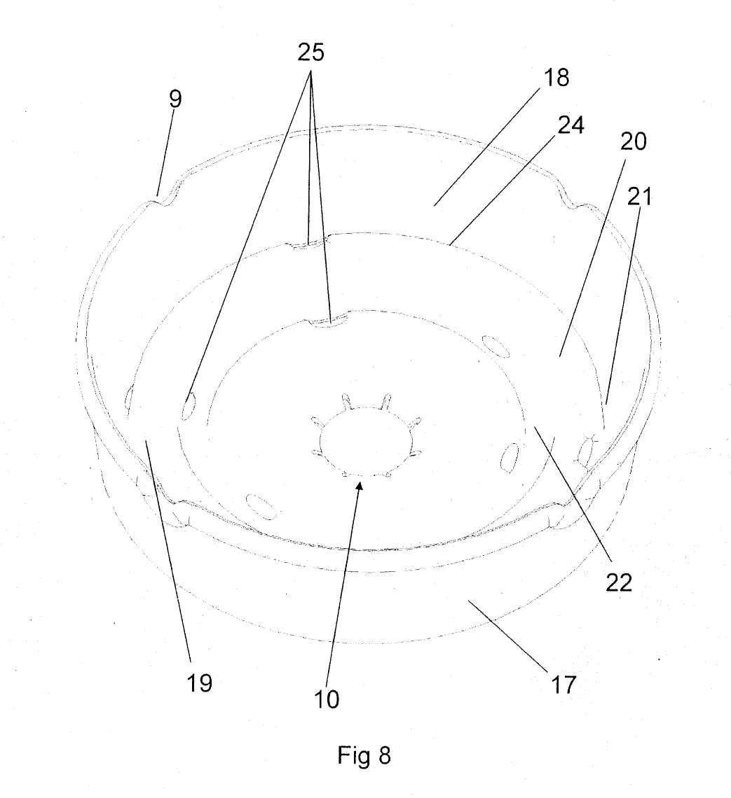

FIGS. 7 and 8 represent an alternative embodiment of the chime 1 according the invention. In this embodiment, the chime comprises four concentrically cylindrical walls 17-18-19-20, the outermost wall 17 defining the skirt of the chime 1.

The outermost wall 17 and the wall adjacent thereto are mutually connected at one of their edges by a transversal rim 21, while the innermost wall 20 and the wall 19 adjacent thereto are mutually connected with another transversal rim 22. Both rims 21 and 22 are preferably situated in a same imaginary plane and define a base of the chime 1. This base is preferably provided with zones 23 of increased roughness to increase grip of the base when positioned on ground.

The free edge of the outermost wall 17 is provided with a peripheral bead 12 and drains 9 corresponding to that described with respect to the chime represented in FIGS. 1 to 4.

The free edges of both intermediate walls 18 and 19 are mutually connected by an annular rim 24, while the free edge of the innermost wall 20 extends in a central hub 3 corresponding to that described with respect to the chime represented in FIGS. 1 to 4 and surrounding the keg bottom finish surround 10.

As will be appreciated from the drawings, drains 25 are provided at the transition of the walls 17 to 20 and the corresponding rims 21, 22 and 24 and at the transition of the innermost wall 20 and the central hub 3.

The application of this alternative chime on a keg is identical to that described with respect to the chime represented in FIGS. 1 to 4.

Finally it is remarked that both the keg and the chime can have various forms. The kegs for example can have a circular cross section, a rectangular cross section or a cross section in any other shape.

1. Container assembly comprising a container and a chime fixed to each other, the container having an end part and a peripheral side wall, characterized in that the fixation between the chime and the container is situated at the end part of the container and at a distance from said peripheral side wall.

2. Container assembly according to claim 1, comprising a container and a bottom chime fixed to each other, the container having a base and a peripheral side wall, characterized in that the fixation between the chime and the container is situated at the base of the container and at a distance from said peripheral side wall.

3. Container assembly according to claim 1, characterized in that the fixation is a releasable fixation.

4. Container assembly according to claim 1, characterized in that the fixation is a snap-fit.

5. Container having a base and a peripheral side wall, characterized in that it is provided with chime attachment means situated at the base at a distance of the containers peripheral side wall.

6. Container according to claim 5, characterized in that the attachment means comprise tapered side walls extending transversally from the base and terminating in an overhanging abutment.

7. Container according to claim 5, characterized in that it is manufactured in a thermoplastic material.

8. Chime having a inner hub and an outer skirt spaced at a distance of the inner hub, characterized in that the chime is provided with fixation means situated at the inner hub thereof.

9. Chime according to claim 8, characterized in that said fixation means has a surround that comprises an opening circumscribed by respective free ends of a plurality of resilient tines extending radially inwardly from the inner hub.

10. Method of manufacturing a container having a base and peripheral sidewall, the method comprising providing attachment means at the base of the container and at a distance of the peripheral sidewall.

11. Method according to claim 10, characterized in that the container is manufactured by molding a melt of thermoplastic material in a mold, whereby said attachment means are created by using a mold with a mold cavity defining a sump region in that part of the mold cavity that corresponds to the base of the container to be formed therein.

12. Method according to claim 11, characterized in that the method further comprises inserting a rod in the mold cavity during molding, whereby the rod extends until in said sump defining region of the mold cavity.

13. Method of manufacturing according to claim 11, wherein a container is manufactured by molding a melt of thermoplastic material in a mold and having a base and peripheral sidewall, the method comprising providing attachment means at the base of the container and at a distance of the peripheral sidewall, said attachment means are created by using a mold with a mold cavity defining a sump region in that part of the mold cavity that corresponds to the base of the container to be formed therein.
